(19) United States
(12) Patent Application Publication
(10) Pub. No.: US 2010/0290859 A1
(43) Pub. Date: Nov. 18, 2010

(54) THREADED ANCHOR FOR CONCRETE METAL DECK FLOORS

(75) Inventors: William T. Noce, Trabuco Canyon, CA (US); Soi Q. Hoang, San Gabriel, CA (US)

Correspondence Address: LEWIS AND ROCA LLP, 1663 Hwy 395, Suite 201, Minden, NV, 89423, US

(73) Assignee: MW Engineering, Placentia, CA (US)

(21) Appl. No.: 12/464,762

(22) Filed: May 12, 2009

(51) Int. Cl. F16B 13/12

(52) U.S. Cl. 411/80.6; 52/745.21

(57) ABSTRACT

A threaded anchor for concrete metal deck floors includes a hollow plastic sleeve having an internally threaded top portion, a flared top end forming several outwardly-extending fingers, and a bottom end. A threaded bolt has a head end and a shaft with external threads mating with the threads of the hollow plastic sleeve. The shaft of the bolt includes internal threads having at least two different diameters. A nut is threaded to mate with the external threads on the bolt. In use, the assembled insert is punched in place through a hole formed in a metal deck layer. The fingers of the plastic sleeve collapse as the assembly is passed through the hole and expand below the deck. The nut is then tightened against the top of the deck to hold the insert in place.

### BACKGROUND

1. Field of the Invention

The present invention relates generally to anchors for poured concrete metal deck floors in multi-story buildings and used as support points for suspended utilities such as plumbing, piping, mechanical equipment, cable trays, bus ducts, HVAC ducts, electrical conduit, conduit racks, junction boxes and the like. More particularly, the present invention pertains to new and improved threaded anchors for poured concrete metal deck floors.

2. The Prior Art

Anchors for concrete wood form and concrete metal deck floors are known in the art. A threaded stud having a plate attached to its body, or an elongated nut having a bolt threaded into one end and a plate attached to its body have been used to provide suspension points for support rods that are used to suspend utilities and utility racks from ceilings, which are formed from concrete poured onto a metal deck floor surface of the floor above.

The size of the support rods utilized in a given application will vary depending on load requirements and upon the kind of utilities that are being suspended. Once anchors are in place, the size of the suspension rods cannot be changed. Moreover, many of these devices are used in the construction of a single building, making the labor required to install them a non-trivial factor.

### BRIEF DESCRIPTION

According to a first aspect of the present invention, a threaded anchor for concrete metal deck floors includes a hollow plastic sleeve having an internally threaded top portion and a flared top end forming several outwardly-extending fingers. A threaded bolt has a head end and a shaft with external threads mating with the threads of the hollow plastic sleeve. The shaft of the bolt includes internal threads having at least two different diameters. A nut is threaded to mate with the external threads on the bolt. In use, the assembled insert is punched in place through a hole formed in a metal deck layer. The fingers of the plastic sleeve collapse as the assembly is passed through the hole and expand below the deck. The nut is then tightened against the top of the deck to hold the insert in place.

In use, the assembled insert is punched in place through a hole formed in a metal deck layer. The fingers of the plastic sleeve collapse as the assembly is passed through the hole and expand below the deck. The nut is then tightened against the top of the deck to hold the insert in place.

According to another aspect of the present invention, the plastic sleeve may be removed from the insert after the concrete above the metal deck layer has cured, and an elongated nut threaded onto the portion of the bolt that extends below the metal deck layer. This allows a larger support rod to be employed with the insert of the present invention.

### BRIEF DESCRIPTION OF THE DRAWING FIGURES

FIG. 1 is a drawing showing an exploded isometric view of all of the components of an illustrative threaded anchor for concrete metal deck floors according to one aspect of the present invention.

FIG. 2 is a cross-sectional view of an illustrative internally-threaded bolt that may be used as a component of a threaded anchor for concrete metal deck floors according to the present invention.

FIG. 3 is a top view of the plastic sleeve component of FIG. 1.

FIG. 4 is a cross-sectional view of an illustrative threaded anchor shown mounted to a concrete metal deck floor according to the present invention.

FIG. 5 is a cross-sectional view of an illustrative threaded anchor shown mounted to a concrete metal deck floor including a support rod threaded into the bolt according to the present invention.

FIG. 6 is a drawing showing a plurality of illustrative threaded anchors for concrete metal deck floors mounted to metal deck flooring including various support rods according to another aspect of the present invention.

### DETAILED DESCRIPTION

Persons of ordinary skill in the art will realize that the following description of the present invention is illustrative only and not in any way limiting. Other embodiments of the invention will readily suggest themselves to such skilled persons.

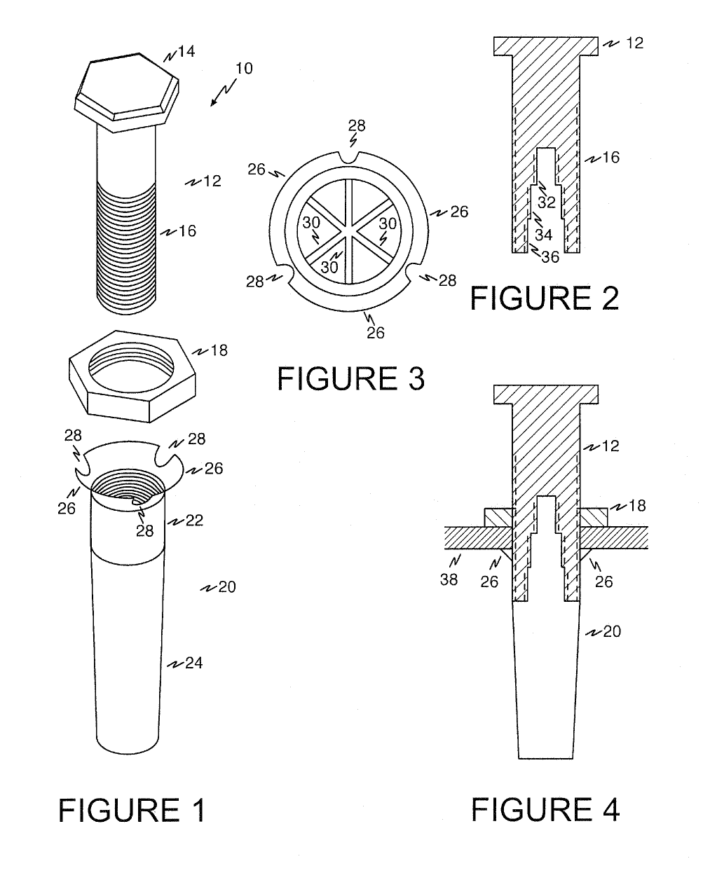

Referring first to FIG. 1, According to a first aspect of the present invention, an exploded view of a threaded anchor 10 for concrete metal deck floors includes a bolt 12 including head 14 and external threads 16. In an exemplary embodiment, bolt 12 may be a ⅞ inch bolt having a 3 inch shaft, a thread length of 2 inches and a head width of 1½ inches although persons skilled in the art will appreciate that this is one example of many possible design configurations. A nut 18 is threaded to mate with bolt 12.

A hollow sleeve 20, formed from a material such as plastic, includes an internally-threaded top portion 22. The internal threads of portion 22 mate with the external threads of bolt 12. A lower portion 24 extends beyond the internally-threaded portion 22 of the body of hollow sleeve 20. Hollow sleeve 20 also includes a flared top end forming several outwardly-extending fingers 26 separated and defined by voids 28. In one example embodiment, plastic sleeve 20 may have an overall height of about 4⅛ inches, with a bottom portion having a height of about 3 inches, a top threaded portion having a height of about 0.88 inches and flared top end having a height of about 0.25 inches. The bottom portion may be tapered as is shown in FIG. 1. Persons skilled in the art will observe that these dimensions (as are the other dimensions suggested herein for other elements of the invention) are not limiting, but merely represent one of a large number of possible embodiments.

Referring now to FIG. 2, it may be seen that bolt 12 includes internal threads having at least two different diameters. The embodiment shown in FIG. 2 includes three internally threaded portions 32, 34, and 36, having different diameters. In an exemplary embodiment, threaded portions 32, 34, and 36 may have lengths of 7/16 inch, 9/16 inch, and ¾ inch, respectively.

Referring now to FIG. 3, a top view of the hollow sleeve 20 shows outwardly extending fingers 26 defined by voids 28. As also may be seen in FIG. 3, the bottom of hollow sleeve 20 is provided with a plurality of slits 30, through which a threaded support rod may be introduced into the body of hollow sleeve 20 and threaded into one of the internally-threaded portions 32, 34, and 36 of bolt 12. In one exemplary non-limiting example embodiment, three 1/32 inch by ⅝ inch slits are employed. The support rod is used to suspend utilities and utility racks from the bottom of the flooring to which the threaded anchor 10 is mounted.

To mount the insert 10, the nut 18 is threaded into the external threads 16 of the bolt 12 and the internal threaded portion 22 of the plastic sleeve 20 is also threaded onto bolt 12. The assembled insert is punched in place through a hole formed in a metal deck layer 38 as shown in FIG. 4. The fingers 26 of the hollow sleeve 20 collapse as the assembly is passed through the hole in the metal deck layer 38 and then expand below the metal deck layer 38 as shown in FIG. 4. The nut 18 is then tightened on bolt 12 against the top of the metal deck layer 38 to hold the insert 10 in place. Because the bolt 12 is held securely to the metal deck layer 38 by the nut 18 and the fingers 26 of the plastic sleeve, the entire insert is disposed at an orientation perpendicular to the metal deck layer 38, and is held there in a stable manner while concrete is poured over the upper surface of metal deck layer 38.

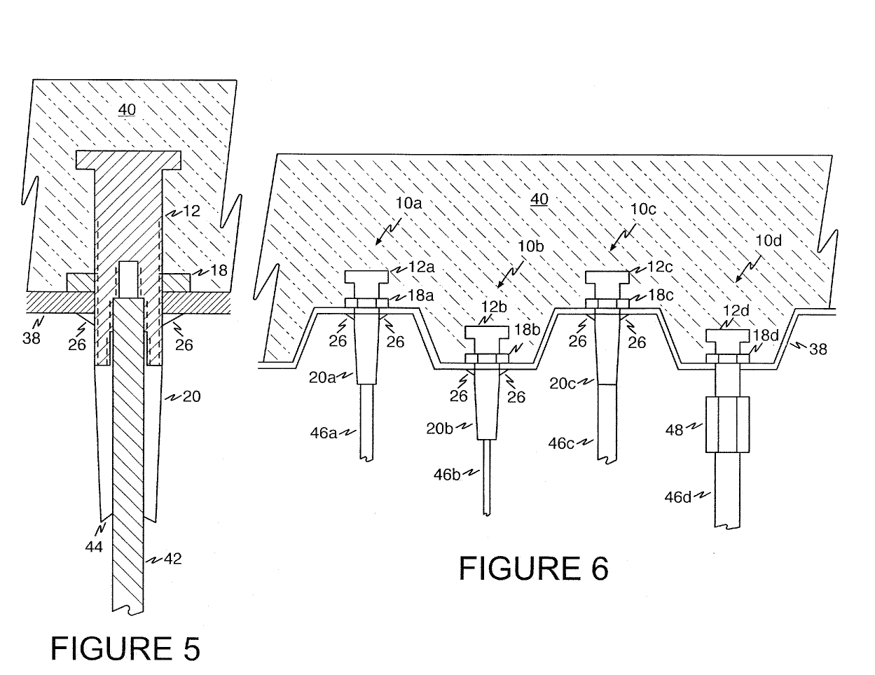

Referring now to FIG. 5, after all of the inserts are mounted to the metal deck layer 38, a layer concrete 40 is poured over the metal deck layer 38 and allowed to cure as is known in the art. A metal support rod 42 is inserted into plastic sleeve 20, deforming the bottom material shown at reference numeral 44 segmented by slits 30 (FIG. 3). An externally-threaded end of metal support rod 42 is then threaded into one of the internally-threaded portions of bolt 12.

Referring now to FIG. 6, other features of the present invention are illustrated. FIG. 6 is a diagram that shows four illustrative inserts 10a through 10d mounted to metal deck layer 38. A layer of concrete 40 has been poured over metal deck layer 38 and allowed to cure as is known in the art.

Insert 10a includes bolt 12a, nut 18a threaded onto bolt 12a, and plastic sleeve 20a threaded onto the portion of bolt 12a extending below the bottom surface of metal deck layer 38. An externally-threaded end of support rod 46a is threaded into one of internal threaded portions 32, 34, and 36 of bolt 12a.

Insert 10b includes bolt 12b, nut 18b threaded onto bolt 12b, and plastic sleeve 20b threaded onto the portion of bolt 12b extending below the bottom surface of metal deck layer 38. An externally-threaded end of support rod 46b is threaded into one of internal threaded portions 32, 34, and 36 of bolt 12b.

Insert 10c includes bolt 12c, nut 18c threaded onto bolt 12c, and plastic sleeve 20c threaded onto the portion of bolt 12c extending below the bottom surface of metal deck layer 38. An externally-threaded end of support rod 46c is threaded into one of internal threaded portions 32, 34, and 36 of bolt 12c.

From an examination of FIG. 5, persons of ordinary skill in the art will observe that support rods 46a, 46b, and 46c have different diameters, support rod 46b having the smallest diameter, and support rod 46c having the largest diameter. This feature of the present invention makes the inserts 10a through 10c more versatile by virtue of the ability to support varying loads. In one exemplary embodiment, support rod 46a may be a ⅝ inch threaded rod, support rod 46b may be a ½ inch threaded rod, and support rod 46c may be a ¾ inch threaded rod, and that internally-threaded portions 32, 34, and 36 of bolts 12a, 12b, and 12c may be matingly configured to match the rods 46a, 46b, and 46c. Exemplary thread configurations are, for example, ⅜ inch −16 UNC 2B thread, ½ inch 13 UNC 2B thread, and ⅝ inch −11 UNC 2b thread, although persons of ordinary skill in the art will readily understand that these configurations are merely examples and that other diameters and thread sizes may be employed.

FIG. 6 also shows an additional feature of the present invention made possible by its configuration is shown with respect to insert 10d. Insert 10d includes bolt 12d, nut 18d threaded onto bolt 12d. Unlike the inserts 10a through 10c, insert 10d has had its hollow sleeve removed. This may be done by simply disengaging the threads between the bolt 12d and the hollow sleeve once the concrete 40 has cured and the bolt 12 is held by the cured concrete so that it will not rotate. An elongated nut 48 is externally threaded onto the bottom portion of bolt 10d that extends below the bottom surface of metal deck layer 38. An externally-threaded end of support rod 46d is threaded into the exposed end of elongated nut 48.

As will be appreciated by persons of ordinary skill in the art, because a larger diameter support rod 46d may be threaded onto elongated nut 48 at the end of bolt 12d, insert 10d is capable of supporting larger loads than would be possible using the largest-diameter support rod 46c that may be internally threaded into any one of bolts 12a through 12c.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A threaded anchor for concrete metal deck floors including:
a hollow sleeve having a top portion including internal threads and a flared top end forming several outwardly-extending fingers, the hollow sleeve further including a bottom end;
a threaded bolt having a head end and a shaft having external threads mating with the internal threads of the hollow plastic sleeve, a distal end of the shaft including at least one internally-threaded portion; and
a nut having threads that mate with the external threads on the bolt.

2. The threaded anchor of claim 1, wherein the at least one internally-threaded portion of the distal end of the shaft of the bolt comprises two internally-threaded portions having different diameters.

3. The threaded anchor of claim 1, wherein the at least one internally-threaded portion of the distal end of the shaft of the bolt comprises three internally-threaded portions having different diameters.

4. The threaded anchor of claim 1, wherein the bolt is at least a ⅞-inch bolt and has a shaft having a length of at least 3 inches.

5. The threaded anchor of claim 1, wherein the hollow sleeve is formed from plastic material.

6. The threaded anchor of claim 1 wherein the bottom end of the hollow sleeve includes a bottom surface having at least one slit formed thereacross.

7. A method for deploying a threaded anchor for concrete metal deck floors including:
providing a hollow sleeve having a top portion including internal threads and a flared top end forming several outwardly-extending fingers, the hollow sleeve further having a bottom end;
providing a threaded bolt having a head end and a shaft having external threads mating with the internal threads of the hollow plastic sleeve, a distal end of the shaft including at least one internally-threaded portion;
providing a nut having threads that mate with the external threads on the bolt;
threading the nut onto the bolt;
threading the hollow sleeve onto the bolt;
pressing the assembled hollow sleeve, bolt, and nut through a hole in a metal deck floor until the flared top end of the hollow sleeve extends below the bottom surface of the metal deck floor;
tightening the nut against the top surface of the metal deck floor; and
poring a layer of concrete over the metal deck floor to a depth sufficient to cover the head end of the bolt.

8. The method of claim 6 further including inserting a metal support rod through the bottom end of the hollow sleeve and threading it onto the at least one internally-threaded portion of the distal end of the shaft of the bolt.

9. The method of claim 6, further including:
removing the hollow sleeve from the bolt after the concrete has been poured;
threading an elongated nut onto the distal end of the shaft of the bolt; and
threading a support rod onto the elongated nut.
